(19) United States
(12) Patent Application Publication
(10) Pub. No.: US 2026/0357888 A1
(43) Pub. Date: Nov. 12, 2026

(54) SHIFT DEVICE

(71) Applicant: KABUSHIKI KAISHA TOKAI-RIKA-DENKI-SEISAKUSHO, Aichi (JP)

(72) Inventors: Makoto YAMAMOTO, Niwa-gun, Aichi (JP); Yutaka INAMURA, Niwa-gun, Aichi (JP); Takuya WATANABE, Niwa-gun, Aichi (JP)

(73) Assignee: KABUSHIKI KAISHA TOKAI-RIKA-DENKI-SEISAKUSHO, Aichi (JP)

(21) Appl. No.: 19/130,686

(22) PCT Filed: Nov. 6, 2023
(86) PCT No.: PCT/JP2023/039916

§ 371 Date: May 16, 2025

(30) Foreign Application Priority Data
Nov. 18, 2022 (JP) 2022-185317

(51) Int. Cl. F16H 59/12

(52) U.S. Cl. CPC F16H 59/12

(57) ABSTRACT

In a shift device, when an occupant touches a P position or an R position, the P position or the R position is selected. Here, a gap between a P electrode and an R electrode is disposed on an “R” display side from a center between “P” display and “R” display. Therefore, it is possible to eliminate a need to separately provide an electrode between the P position and the R position.

### TECHNICAL FIELD

The present invention relates to a shift device in which a shift position is selectable.

### BACKGROUND ART

In an input device disclosed in DE 102014009355A1, each pair of touch sensor surfaces detects touch on each functional recess, and each shift position corresponding to each functional recess is selected.

Here, in the input device, the pair of touch sensor surfaces is separately disposed between the functional recesses.

### SUMMARY OF INVENTION

### Technical Problem

In view of the above circumstances, an object of the invention is to obtain a shift device capable of eliminating a need to separately provide a detection unit between shift positions.

### Solution to Problem

According to a first aspect of the invention, a first shift position at which a first shift display is provided; a first detection unit that detects a touch on the first shift position and selects the first shift position; a second shift position at which a second shift display is provided; and a second detection unit that has a gap from the first detection unit at a second shift display side from a center between the first shift display and the second shift display and that detects a touch on the second shift position and selects the second shift position.

According to a second aspect of the invention, in the shift device according to the first aspect of the invention, the first detection unit is disposed at a center position between the first shift display and the second shift display.

According to a third aspect of the invention, in the shift device according to the first or second aspect of the invention, the first shift position is set to a shift position at which a vehicle is not driven, and the second shift position is set to a shift position at which the vehicle is driven.

According to a fourth aspect of the invention, in the shift device according to any one of the first to third aspects of the invention, a boundary portion is provided between the first shift display and the second shift display.

According to a fifth aspect of the invention, in the shift device according to the fourth aspect of the invention, the first detection unit is disposed at a position of the boundary portion.

According to a sixth aspect of the invention, in the shift device according to the fourth aspect of the invention, the gap between the first detection unit and the second detection unit is disposed at a position of a boundary portion.

### Advantageous Effects of Invention

In the shift device according to the first aspect of the invention, the first detection unit detects a touch on the first shift position, and the first shift position is selected. The second detection unit detects a touch on the second shift position, and the second shift position is selected.

Here, the gap between the first detection unit and the second detection unit is disposed at the second shift display side from the center between the first shift display of the first shift position and the second shift display of the second shift position. Therefore, it is possible to eliminate a need to separately provide a detection unit between the first shift position and the second shift position.

In the shift device according to the second aspect of the invention, the first detection unit is disposed at the center position between the first shift display and the second shift display. Therefore, when the center between the first shift position and the second shift display is touched, the first shift position can be preferentially selected with respect to the second shift position.

In the shift device according to the third aspect of the invention, the first shift position is set to a shift position at which the vehicle is not driven, and the second shift position is set to a shift position at which the vehicle is driven. Therefore, even though the first shift position is selected when a portion between the first shift display and the second shift display is touched, it is possible to suppress driving of the vehicle.

In the shift device according to the fourth aspect of the invention, the boundary portion is provided between the first shift display and the second shift display. Therefore, it is possible to suppress touch on a portion between the first shift display and the second shift display for a predetermined time or longer.

In the shift device according to the fifth aspect of the invention, the first detection unit is disposed at the position of the boundary portion. Therefore, even though the boundary portion is touched, the first shift position can be preferentially selected with respect to the second shift position.

In the shift device according to the sixth aspect of the invention, the gap between the first detection unit and the second detection unit is disposed at the position of the boundary portion. Therefore, even if the boundary portion is touched, it is possible to suppress the selection of the first shift position and the second shift position.

### BRIEF DESCRIPTION OF DRAWINGS

FIG. 1 is a front view illustrating a shift device according to a first embodiment of the invention as viewed from a front side.

FIG. 2 is a cross-sectional view illustrating the shift device according to the first embodiment of the invention as viewed from below.

FIG. 3 is a front view illustrating a shift device according to a second embodiment of the invention as viewed from the front side.

FIG. 4 is a front view illustrating a shift device according to a third embodiment of the invention as viewed from the front side.

### DESCRIPTION OF EMBODIMENTS

### First Embodiment

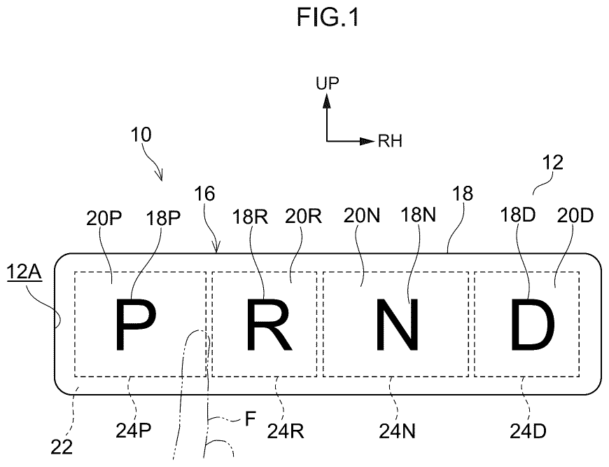

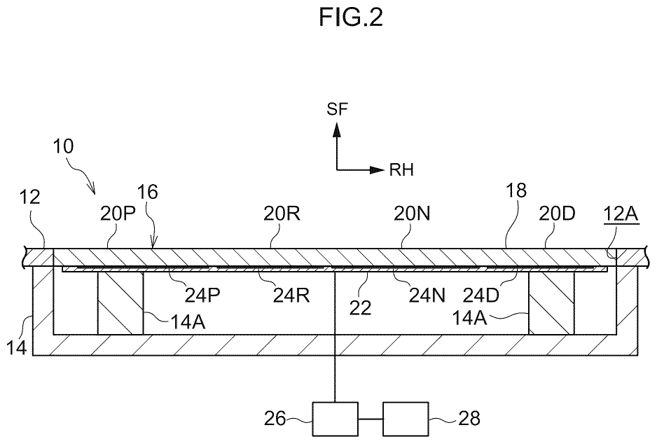

FIG. 1 is a front view of a shift device 10 according to a first embodiment of the invention as viewed from a front side, and FIG. 2 is a cross-sectional view of the shift device 10 as viewed from below. In the drawings, the front side of the shift device 10 is indicated by an arrow SF, the right side of the shift device 10 is indicated by an arrow RH, and the upper side of the shift device 10 is indicated by an arrow UP.

As illustrated in FIGS. 1 and 2, the shift device 10 according to the present embodiment is installed at the center portion of an instrument panel 12 of a vehicle (automobile) in a vehicle width direction, and is disposed inside a steering wheel (not illustrated) of the vehicle in the vehicle width direction. The front side, the right side, and the upper side of the shift device 10 are directed to the rear side, the right side, and the upper side of the vehicle, respectively.

The shift device 10 is provided with a case 14 having a substantially rectangular parallelepiped box shape as an installation body, and the case 14 is fixed to the vehicle front side of the instrument panel 12. The case 14 is elongated in the right-left direction, and the inside of the case 14 is open to the front side. In the instrument panel 12, a rectangular opening 12A is formed on the vehicle rear side of the case 14, and the inside of the case 14 faces the opening 12A. A plurality of fixed columns 14A are provided in the case 14, and the fixed columns 14A protrude from the back side wall of the case 14 to the front side.

A rectangular plate-shaped panel 16 as a touch body is provided on the front side of the case 14, and the panel 16 is fixed to the front side of the fixed column 14A of the case 14 and fitted to the opening 12A of the instrument panel 12.

A rectangular plate-shaped plate 18 as a touch member is provided at the front side portion of the panel 16, and the plate 18 is made of resin, for example, and is made of an insulator. The front surface of the plate 18 is disposed to be flush with the vehicle rear side surface of the instrument panel 12, and the front surface of the plate 18 constitutes a design surface of the vehicle interior of the vehicle together with the vehicle rear side surface of the instrument panel 12. Therefore, the front surface of the plate 18 can be touched by an occupant (particularly, a driver) of the vehicle with a finger F.

A P position 20P (park position) as a first shift position, an R position 20R (reverse position) as a second shift position, an N position 20N (neutral position) as a first shift position, and a D position 20D (drive position) as a second shift position are provided on the front surface of the plate 18. The P position 20P, the R position 20R, the N position 20N, and the D position 20D are arranged in the right-left direction and disposed in this order from the left side to the right side. The P position 20P, the R position 20R, the N position 20N, and the D position 20D are formed in a rectangular shape, and the up-down direction dimensions of the P position 20P, the R position 20R, the N position 20N, and the D position 20D are made be the same. The right-left direction dimension of the N position 20N is made larger than the right-left direction dimension of the P position 20P, and the right-left direction dimensions of the R position 20R and the D position 20D are made be the same. The right-left direction dimensions of the P position 20P and the N position 20N are made larger than the right-left direction dimensions of the R position 20R and the D position 20D.

A “P” display 18P as a first shift display, an “R” display 18R as a second shift display, an “N” display 18N as a first shift display, and a “D” display 18D as a second shift display are displayed in a substantially center portion of the P position 20P, the center portion of the R position 20R, the center portion of the N position 20N, and the center portion of the D position 20D, respectively. A right-left direction interval between the right-left direction center of the “P” display 18P and the right-left direction center of the “R” display 18R, a right-left direction interval between the right-left direction center of the “R” display 18R and the right-left direction center of the “N” display 18N, and a right-left direction interval between the right-left direction center of the “N” display 18N and the right-left direction center of the “D” display 18D are made be the same, and the “P” display 18P, the “R” display 18R, the “N” display 18N, and the “D” display 18D are arranged at equal intervals in the right-left direction.

A rectangular sheet-shaped electrostatic sheet 22 as a detection unit is fixed to the back side of the plate 18, and the electrostatic sheet 22 covers the back side surface of the plate 18.

A P electrode 24P as a first detection unit, an R electrode 24R as a second detection unit, an N electrode 24N as a first detection unit, and a D electrode 24D as a second detection unit are provided on the front side of the electrostatic sheet 22, and the P electrode 24P, the R electrode 24R, the N electrode 24N, and the D electrode 24D are arranged in this order from the left side to the right side. The P electrode 24P, the R electrode 24R, the N electrode 24N, and the D electrode 24D are made of, for example, metal and have conductivity, and the P electrode 24P, the R electrode 24R, the N electrode 24N, and the D electrode 24D are formed in a rectangular film shape. The entirety of each of the P electrode 24P, the R electrode 24R, the N electrode 24N, and the D electrode 24D faces the entirety of each of the P position 20P, the R position 20R, the N position 20N, and the D position 20D in the front-back direction (thickness direction of the plate 18), and the up-down direction dimensions of the P electrode 24P, the R electrode 24R, the N electrode 24N, and the D electrode 24D are made be the same.

The right-left direction dimension of the N electrode 24N is made larger than the right-left direction dimension of the P electrode 24P, and the right-left direction dimensions of the R electrode 24R and the D electrode 24D are made be the same. The right-left direction dimensions of the P electrode 24P and the N electrode 24N are made larger than the right-left direction dimensions of the R electrode 24R and the D electrode 24D. The P electrode 24P is disposed at a right-left direction center position between the right-left direction center of the “P” display 18P and the right-left direction center of the “R” display 18R. The N electrode 24N is disposed at a right-left direction center position between the right-left direction center of the “R” display 18R and the right-left direction center of the “N” display 18N, and the N electrode 24N is disposed at a right-left direction center position between the right-left direction center of the “N” display 18N and the right-left direction center of the “D” display 18D.

The P electrode 24P, the R electrode 24R, the N electrode 24N, and the D electrode 24D of the electrostatic sheet 22 are electrically connected to a control device 26 of the vehicle, and a transmission 28 (automatic transmission) of the vehicle is electrically connected to the control device 26. The control device 26 is provided with a microcomputer in which a CPU, a ROM, a RAM, a non-volatile memory (storage), and the like are connected by a bus. In the control device 26, the CPU reads a program stored in the ROM and the storage and executes the program while loading the program in the RAM, thereby implementing various functions.

Next, the operation of the present embodiment will be described.

In the shift device 10 having the above configuration, the “P” display 18P, the “R” display 18R, the “N” display 18N, and the “D” display 18D are provided at the P position 20P, the R position 20R, the N position 20N, and the D position 20D of the panel 16 (plate 18), respectively.

When the occupant touches the P position 20P, the R position 20R, the N position 20N, or the D position 20D with the finger F, electrostatic capacitance is generated between the finger F, and the P electrode 24P, the R electrode 24R, the N electrode 24N, or the D electrode 24D of the panel 16 (electrostatic sheet 22), respectively (touch of the finger F on the P position 20P, the R position 20R, the N position 20N, or the D position 20D is detected). In a case in which the electrostatic capacitance (selected value) between the finger F, and the P electrode 24P, the R electrode 24R, the N electrode 24N, or the D electrode 24D is equal to or larger than a capacitance threshold value for a time equal to or longer than a time threshold value (for example, a predetermined time of 0.5 seconds), the control device 26 determines that the P position 20P, the R position 20R, the N position 20N, or the D position 20D is selected, and the shift range of the transmission 28 is changed to the corresponding P range (park range), R range (reverse range), N range (neutral range), or D range (drive range) under the control of the control device 26.

Here, the right-left direction center of the gap between the P electrode 24P and the R electrode 24R is disposed on the “R” display 18R side from the right-left direction center between the “P” display 18P and the “R” display 18R (between the right-left direction center of the “P” display 18P and the right-left direction center of the “R” display 18R), and the P electrode 24P is enlarged on the R electrode 24R side. Therefore, it is possible to eliminate a need to separately provide an electrode (detection unit) between the P position 20P and the R position 20R. When the finger F of the occupant touches the right-left direction center of the panel 16 between the “P” display 18P and the “R” display 18R, the electrostatic capacitance between the finger F and the P electrode 24P can be increased, and the P position 20P can be preferentially selected with respect to the R position 20R.

Moreover, the P electrode 24P is disposed at the right-left direction center position between the “P” display 18P and the “R” display 18R. Therefore, when the finger F of the occupant touches the right-left direction center of the panel 16 between the “P” display 18P and the “R” display 18R, the electrostatic capacitance between the finger F and the P electrode 24P can be appropriately increased, and the P position 20P can be appropriately preferentially selected with respect to the R position 20R.

The P position 20P is set to a shift position at which the vehicle is not driven, and the R position 20R is set to a shift position at which the vehicle is driven. Therefore, when the finger F of the occupant touches the right-left direction center of the panel 16 between the “P” display 18P and the “R” display 18R, the P position 20P is preferentially selected with respect to the R position 20R, whereby it is possible to suppress driving of the vehicle.

Further, the right-left direction center of the gap between the R electrode 24R and the N electrode 24N is disposed on the “R” display 18R side from the right-left direction center between the “R” display 18R and the “N” display 18N (between the right-left direction center of the “R” display 18R and the right-left direction center of the “N” display 18N), and the N electrode 24N is enlarged on the R electrode 24R side. Therefore, it is possible to eliminate a need to separately provide an electrode (detection unit) between the R position 20R and the N position 20N. When the finger F of the occupant touches the right-left direction center of the panel 16 between the “R” display 18R and the “N” display 18N, the electrostatic capacitance between the finger F and the N electrode 24N can be increased, and the N position 20N can be preferentially selected with respect to the R position 20R.

Moreover, the N electrode 24N is disposed at the right-left direction center position between the “R” display 18R and the “N” display 18N. Therefore, when the finger F of the occupant touches the right-left direction center of the panel 16 between the “R” display 18R and the “N” display 18N, the electrostatic capacitance between the finger F and the N electrode 24N can be appropriately increased, and the N position 20N can be appropriately preferentially selected with respect to the R position 20R.

The N position 20N is set to a shift position at which the vehicle is not driven, and the R position 20R is set to a shift position at which the vehicle is driven. Therefore, when the finger F of the occupant touches the right-left direction center of the panel 16 between the “R” display 18R and the “N” display 18N, the N position 20N is preferentially selected with respect to the R position 20R, whereby it is possible to suppress driving of the vehicle.

Further, the right-left direction center of the gap between the N electrode 24N and the D electrode 24D is disposed on the “D” display 18D side from the right-left direction center between the “N” display 18N and the “D” display 18D (between the right-left direction center of the “N” display 18N and the right-left direction center of the “D” display 18D), and the N electrode 24N is enlarged on the D electrode 24D side. Therefore, it is possible to eliminate a need to separately provide an electrode (detection unit) between the N position 20N and the D position 20D. When the finger F of the occupant touches the right-left direction center of the panel 16 between the “N” display 18N and the “D” display 18D, the electrostatic capacitance between the finger F and the N electrode 24N can be increased, and the N position 20N can be preferentially selected with respect to the D position 20D.

Moreover, the N electrode 24N is disposed at the right-left direction center position between the “N” display 18N and the “D” display 18D. Therefore, when the finger F of the occupant touches the right-left direction center of the panel 16 between the “N” display 18N and the “D” display 18D, the electrostatic capacitance between the finger F and the N electrode 24N can be appropriately increased, and the N position 20N can be appropriately preferentially selected with respect to the D position 20D.

The N position 20N is set to a shift position at which the vehicle is not driven, and the D position 20D is set to a shift position at which the vehicle is driven. Therefore, when the finger F of the occupant touches the right-left direction center of the panel 16 between the “N” display 18N and the “D” display 18D, the N position 20N is preferentially selected with respect to the D position 20D, whereby it is possible to suppress driving of the vehicle.

### Second Embodiment

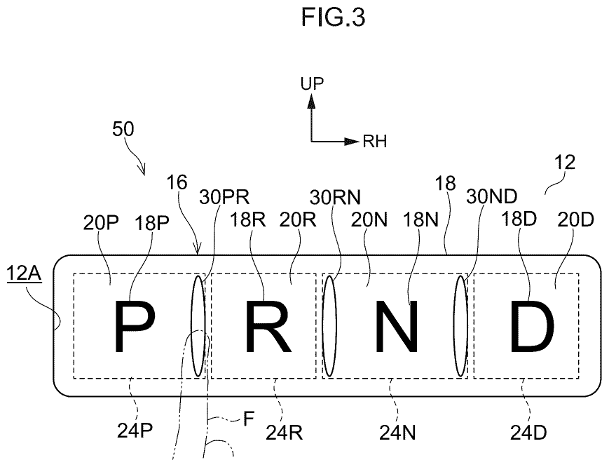

FIG. 3 is a front view of a shift device 50 according to a second embodiment of the invention as viewed from the front side.

The shift device 50 according to the present embodiment has substantially the same configuration as that of the first embodiment, but differs in the following points.

As illustrated in FIG. 3, in the shift device 50 according to the present embodiment, in the panel 16, a PR protrusion 30PR, an RN protrusion 30RN, and an ND protrusion 30ND, which have a long columnar shape, as boundary portions are integrally provided on the front surface of the plate 18, and each of the PR protrusion 30PR, the RN protrusion 30RN, and the ND protrusion 30ND protrudes to the front side and extends in the up-down direction.

The PR protrusion 30PR is disposed between the “P” display 18P and the “R” display 18R on the plate 18, and the right-left direction center of the PR protrusion 30PR is disposed at the right-left direction center between the right-left direction center of the “P” display 18P and the right-left direction center of the “R” display 18R. Therefore, the PR protrusion 30PR is disposed at the P position 20P and is disposed at the position of the P electrode 24P of the electrostatic sheet 22.

The RN protrusion 30RN is disposed between the “R” display 18R and the “N” display 18N on the plate 18, and the right-left direction center of the RN protrusion 30RN is disposed at the right-left direction center between the right-left direction center of the “R” display 18R and the right-left direction center of the “N” display 18N. Therefore, the RN protrusion 30RN is disposed at the N position 20N and is disposed at the position of the N electrode 24N of the electrostatic sheet 22.

The ND protrusion 30ND is disposed between the “N” display 18N and the “D” display 18D on the plate 18, and the right-left direction center of the ND protrusion 30ND is disposed at the right-left direction center between the right-left direction center of the “N” display 18N and the right-left direction center of the “D” display 18D. Therefore, the ND protrusion 30ND is disposed at the N position 20N and is disposed at the position of the N electrode 24N of the electrostatic sheet 22.

Here, also in the present embodiment, the same operations and effects as those of the first embodiment can be obtained.

In addition, the PR protrusion 30PR is provided at the right-left direction center between the “P” display 18P and the “R” display 18R (between the right-left direction center of the “P” display 18P and the right-left direction center of the “R” display 18R). Therefore, it is possible to suppress the touch of the finger F of the occupant on the right-left direction center between the “P” display 18P and the “R” display 18R of the panel 16 for a time equal to or longer than the time threshold value, and it is possible to suppress the selection of the P position 20P and the R position 20R.

Further, the P electrode 24P is disposed at the position of the PR protrusion 30PR. Therefore, even though the finger F of the occupant touches the PR protrusion 30PR, the P position 20P can be preferentially selected with respect to the R position 20R.

In addition, the RN protrusion 30RN is provided at the right-left direction center between the “R” display 18R and the “N” display 18N (between the right-left direction center of the “R” display 18R and the right-left direction center of the “N” display 18N). Therefore, it is possible to suppress the touch of the finger F of the occupant on the right-left direction center between the “R” display 18R and the “N” display 18N of the panel 16 for a time equal to or longer than the time threshold value, and it is possible to suppress the selection of the R position 20R and the N position 20N.

The N electrode 24N is disposed at the position of the RN protrusion 30RN. Therefore, even though the finger F of the occupant touches the RN protrusion 30RN, the N position 20N can be preferentially selected with respect to the R position 20R.

In addition, the ND protrusion 30ND is provided at the right-left direction center between the “N” display 18N and the “D” display 18D (between the right-left direction center of the “N” display 18N and the right-left direction center of the “D” display 18D). Therefore, it is possible to suppress the touch of the finger F of the occupant on the right-left direction center between the “N” display 18N and the “D” display 18D of the panel 16 for a time equal to or longer than the time threshold value, and it is possible to suppress the selection of the N position 20N and the D position 20D.

Further, the N electrode 24N is disposed at the position of the ND protrusion 30ND. Therefore, even though the finger F of the occupant touches the ND protrusion 30ND, the N position 20N can be preferentially selected with respect to the D position 20D.

### Third Embodiment

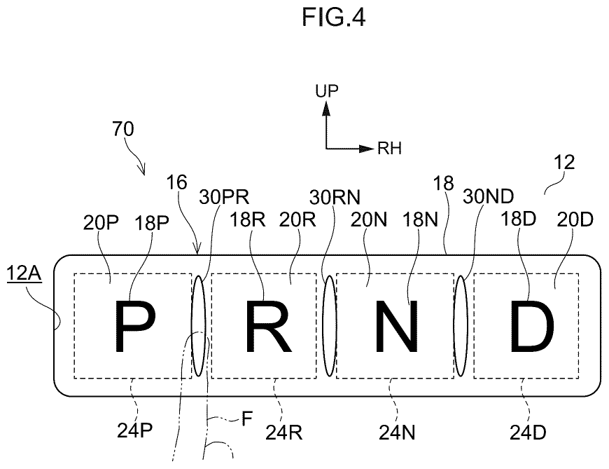

FIG. 4 is a front view of a shift device 70 according to a third embodiment of the invention as viewed from the front side.

The shift device 70 according to the present embodiment has substantially the same configuration as that of the second embodiment, but differs in the following points.

As illustrated in FIG. 4, in the shift device 70 according to the present embodiment, in the panel 16, the P electrode 24P of the electrostatic sheet 22 has the right end disposed on the left side to reduce the right-left direction dimension, and a gap between the P electrode 24P and the R electrode 24R is disposed at the right-left direction center position between the right-left direction center of the “P” display 18P and the right-left direction center of the “R” display 18R. The PR protrusion 30PR of the plate 18 is disposed on the right side of the P position 20P of the plate 18, and the PR protrusion 30PR is not disposed at the position of the P electrode 24P.

The N electrode 24N of the electrostatic sheet 22 has a left end disposed on the right side to reduce the right-left direction dimension, and a gap between the R electrode 24R and the N electrode 24N is disposed at the right-left direction center position between the right-left direction center of the “R” display 18R and the right-left direction center of the “N” display 18N. The RN protrusion 30RN of the plate 18 is disposed on the left side of the N position 20N of the plate 18, and the RN protrusion 30RN is not disposed at the position of the N electrode 24N.

The N electrode 24N of the electrostatic sheet 22 has a left end disposed on the right side to further reduce the right-left direction dimension, and the gap between the N electrode 24N and the D electrode 24D is disposed at the right-left direction center position between the right-left direction center of the “N” display 18N and the right-left direction center of the “D” display 18D. The ND protrusion 30ND of the plate 18 is disposed on the right side of the N position 20N of the plate 18, and the ND protrusion 30ND is not disposed at the position of the N electrode 24N. The N position 20N and the right-left direction dimension of the N electrode 24N are the same as the P position 20P and the right-left direction dimension of the P electrode 24P.

Here, also in the present embodiment, the same operations and effects as those of the first embodiment can be obtained.

In particular, the gap between the P electrode 24P and the R electrode 24R is disposed at a right-left direction center position between the “P” display 18P and the “R” display 18R (between the right-left direction center of the “P” display 18P and the right-left direction center of the “R” display 18R). Therefore, when the finger F of the occupant touches the right-left direction center between the “P” display 18P and the “R” display 18R of the panel 16, it is possible to suppress the selection of the P position 20P and the R position 20R.

Further, the PR protrusion 30PR is provided at the right-left direction center between the “P” display 18P and the “R” display 18R. Therefore, it is possible to suppress the touch of the finger F of the occupant on the right-left direction center between the “P” display 18P and the “R” display 18R of the panel 16 for a time equal to or longer than the time threshold value, and it is possible to further suppress the selection of the P position 20P and the R position 20R.

In addition, the gap between the R electrode 24R and the N electrode 24N is disposed at the right-left direction center position between the “R” display 18R and the “N” display 18N (between the right-left direction center of the “R” display 18R and the right-left direction center of the “N” display 18N). Therefore, when the finger F of the occupant touches the right-left direction center between the “R” display 18R and the “N” display 18N of the panel 16, it is possible to suppress the selection of the R position 20 and the N position 20N.

The RN protrusion 30RN is provided at the right-left direction center between the “R” display 18R and the “N” display 18N. Therefore, it is possible to suppress the touch of the finger F of the occupant on the right-left direction center between the “R” display 18R and the “N” display 18N of the panel 16 for a time equal to or longer than the time threshold value, and it is possible to further suppress the selection of the R position 20R and the N position 20N.

In addition, the gap between the N electrode 24N and the D electrode 24D is disposed at the right-left direction center position between the “N” display 18N and the “D” display 18D (between the right-left direction center of the “N” display 18N and the right-left direction center of the “D” display 18D). Therefore, when the finger F of the occupant touches the right-left direction center between the “N” display 18N and the “D” display 18D of the panel 16, it is possible to suppress the selection of the N position 20N and the R position 20R.

The ND protrusion 30ND is provided at the right-left direction center between the “N” display 18N and the “D” display 18D. Therefore, it is possible to suppress the touch of the finger F of the occupant on the right-left direction center between the “N” display 18N and the “D” display 18D of the panel 16 for a time equal to or longer than the time threshold value, and it is possible to further suppress the selection of the N position 20N and the D position 20D.

In the second embodiment and the third embodiment, the PR protrusion 30PR, the RN protrusion 30RN, and the ND protrusion 30ND (boundary portions) are formed as protrusions. However, the boundary portion may be formed as a recess and the boundary portion may be displayed.

In the second embodiment and the third embodiment, the PR protrusions 30PR, the RN protrusions 30RN, and the ND protrusions 30ND are arranged at equal intervals. The PR protrusions 30PR, the RN protrusions 30RN, and the ND protrusions 30ND need not be arranged at equal intervals.

In the first to third embodiments, the “P” display 18P, the “R” display 18R, the “N” display 18N, and the “D” display 18D are arranged at equal intervals. The “P” display 18P, the “R” display 18R, the “N” display 18N, and the “D” display 18D need not be arranged at equal intervals.

Furthermore, in the first to third embodiments, the “P” display 18P, the “R” display 18R, the “N” display 18N, and the “D” display 18D (including the P position 20P, the R position 20R, the N position 20N, and the D position 20D, and the P electrode 24P, the R electrode 24R, the N electrode 24N, and the D electrode 24D) are arranged in the right-left direction. The “P” display 18P, the “R” display 18R, the “N” display 18N, and the “D” display 18D (including the P position 20P, the R position 20R, the N position 20N, and the D position 20D, and the P electrode 24P, the R electrode 24R, the N electrode 24N, and the D electrode 24D) may be arranged in a direction other than the right-left direction (for example, the up-down direction).

In the first to third embodiments, the shift devices 10, 50, and 70 are installed on the instrument panel. The shift devices 10, 50, and 70 may be installed in other parts of the vehicle (such as a console or a column cover).

The disclosure of Japanese Patent Application No. 2022-185317, filled on Nov. 18, 2022, is incorporated herein by reference in its entirety.

### REFERENCE SIGNS LIST

10 shift device
18P “P” display (first shift display)
18R “R” display (second shift display)
18N “N” display (first shift display)
18D “D” display (second shift display)
20P P position (first shift position)
20R R position (second shift position)
20N N position (first shift position)
20D D position (second shift position)
24P P electrode (first detection unit)
24R R electrode (second detection unit)
24N N electrode (first detection unit)
24D D electrode (second detection unit)
30PR PR protrusion (boundary portion)
30RN RN protrusion (boundary portion)
30ND ND protrusion (boundary portion)
50 shift device
70 shift device

1. A shift device, comprising:
a first shift position at which a first shift display is provided;
a first detection unit that detects a touch on the first shift position and selects the first shift position;
a second shift position at which a second shift display is provided; and
a second detection unit that has a gap from the first detection unit at a second shift display side from a center between the first shift display and the second shift display and that detects a touch on the second shift position and selects the second shift position.

2. The shift device according to claim 1, wherein the first detection unit is disposed at a center position between the first shift display and the second shift display.

3. The shift device according to claim 1, wherein the first shift position is set to a shift position at which a vehicle is not driven, and the second shift position is set to a shift position at which the vehicle is driven.

4. The shift device according to claim 1, wherein a boundary portion is provided between the first shift display and the second shift display.

5. The shift device according to claim 4, wherein the first detection unit is disposed at a position of the boundary portion.

6. The shift device according to claim 4, wherein the gap between the first detection unit and the second detection unit is disposed at a position of the boundary portion.

7. The shift device according to claim 4, wherein the boundary portion is a protrusion, a recess, or a display.

8. The shift device according to claim 1, wherein a dimension of the first detection unit is larger than a dimension of the second detection unit.

9. The shift device according to claim 1, wherein the first shift display is disposed at a side opposite to the second detection unit from a center of the first detection unit.
